(19) United States
(12) Patent Application Publication
(10) Pub. No.: US 2017/0028665 A1
(43) Pub. Date: Feb. 2, 2017

(54) BOX AND RESPECTIVE SELF-ASSEMBLING METHOD

(71) Applicants: Daniela Catia FERREIRA DA ROCHA FELIX, Espinho (PT); Ana Filipa FERREIRA DA ROCHA FELIX, Espinho (PT)

(72) Inventors: Daniela Catia FERREIRA DA ROCHA FELIX, Espinho (PT); Ana Filipa FERREIRA DA ROCHA FELIX, Espinho (PT)

(21) Appl. No.: 15/303,997

(22) PCT Filed: Mar. 16, 2015
(86) PCT No.: PCT/IB2015/051907

§ 371 Date: Oct. 13, 2016

(30) Foreign Application Priority Data
Apr. 15, 2014 (PT) 107587

(51) Int. Cl. B31B 3/60; B65D 5/66; B65D 5/24

(52) U.S. Cl. CPC B31B 3/60; B65D 5/241; B65D 5/6626; B65D 5/6629; B31B 2203/084; B31B 2201/26; B31B 2201/6017

(57) ABSTRACT

The present application describes a box and its self-assembling method. The box is obtained from a sheet of material comprising a crease at a distance of half width of the box from the lower small end (1), a crease at a distance of one height plus half width of the box from the lower smaller end (2), a crease at a distance of one height plus one and a half width of the box from the lower smaller end (3), a crease at a distance of twice the height plus one and a half width of the box from the lower smaller end (4), a crease at a distance equal to one height of the box from the larger left end (5), a crease at a distance equal to one height plus one length of the box from the larger left end (6), diagonal creases (7) and sticking points (8).

### TECHNICAL DOMAIN

The present application describes a box, its self-assembling method and use thereof.

### STATE OF THE ART

From the prior art is known the existence of self-assembling boxes that enable simplified assembly from a sheet of material, for example paper. Throughout the present application, a sheet of material is considered as the starting sheet for obtaining the self-assembling box made with the material desired by the user.

Document JP2013052884 discloses a paper container capable of being assembled by firmly joining paper plates using a locking mechanism. However, the disclosed technique in the present application does not imply the use of a locking mechanism, simply by gluing and folding a sheet of material to obtain a box with considerable mechanical strength.

Document CN202912041 discloses a container comprised of a paper sheet of material folds upon itself and four independent paper bodies placed on top of the referred folded sheet of material. However, the disclosed technique in the present application does not imply the use of additional bodies in addition to the sheet of material, simply by gluing and folding that same sheet of material to obtain a box with considerable mechanical strength.

### SUMMARY

The present application describes a method for self-assembling a box comprising the following steps:
Placement of a sheet of material on a stable basis;
Elaboration of a crease at a distance of half width of the box from the lower smaller end (1) perpendicular to the length direction of the sheet of material;
Elaboration of a crease at a distance of one height plus half the width of the box from the lower smaller end (2) parallel to the crease made in the previous step;
Elaboration of a crease at a distance of one height plus one and a half width of the box from the lower smaller end (3) parallel to the crease made in the previous step;
Elaboration of a crease at a distance of one and a half width plus twice the height of the box from the lower smaller end (4) parallel to the crease made in the previous step;
Elaboration of a crease at a distance equal to one height of the box from the larger left end (5), perpendicular to the width direction of the sheet of material;
Elaboration of a crease at a distance equal to one height plus the length of the box from the larger left end (6), parallel to the crease made in the previous step;
Elaboration of four diagonal creases (7);
Introduction of some glue lines in four specific points of the sheet of material;
Folding of the crease at a distance equal to the height of the box from the larger left end (5);
Folding of the crease at a distance equal to the height plus the length of the box from the larger left end (6);
The above folding glue the areas now in contact;
The creases are folded, placed horizontally to the sheet of material.

In one embodiment, the sheet of material used in the assembling method of a box is corrugated paper, cardboard or compact cardboard.

The present application further describes the self-assembling box obtained by the assembling method mentioned above.

The present application further describes the use of self-assembling box for transportation of objects and/or food products.

### GENERAL DESCRIPTION

The present application describes a self-assembling box that has a new packaging concept. This new packaging concept is translated in the development of an assembling process.

Through this new assembling process of a self-assembling box it is possible to obtain a box with a bottom without closing or of compact bottom in a quick and easy way. Thus, once the bottom of these packaging is totally compact, safe transport is ensured, an adequate presentation of the packaged product, in addition to maintaining a mechanical resistance significantly improved with an exceptional performance at stacking level.

This type of packaging may be used throughout the industry, and said method may be applied in the execution of all existing box models.

With this new assembling process one attains the easiest way for obtaining a self-assembling box that, when ready, features a completely hermetic closing system without the use of tape. Becoming thus more resistant than any other box currently on the market.

### BRIEF DESCRIPTION OF THE FIGURES

For easier understanding of the embodiment, accompanying drawings are joined which represent preferred embodiments that however are not intended to limit the object of the present embodiment.

FIG. 1 illustrates one embodiment of the self-assembling box for obtaining an American model box with compact bottom, where the reference numbers represent:

1—Crease at a distance of half width of the box from the lower smaller end;

2—Crease at a distance of one height plus half the width of the box from the lower smaller end;

3—Crease at a distance of one height plus one and a half width of the box from the lower smaller end;

4—Crease at a distance twice the height plus one and a half width of the box from the lower smaller end;

5—Crease at a distance equal the height of the box from the larger left end;

6—Crease at a distance equal to one height plus one length of the box from the larger left end;

7—Diagonal creases.

FIG. 2 illustrates one embodiment of the self-assembling box for obtaining a box with cover and compact bottom, where the reference numbers represent:

1—Crease at a distance of half width of the box from the lower smaller end;

2—Crease at a distance of one height plus half the width of the box from the lower smaller end;

3—Crease at a distance of one height plus one and a half width of the box from the lower smaller end;

4—Crease at a distance twice the height plus one and a half width of the box from the lower smaller end;

5—Crease at a distance equal the height of the box from the larger left end;

6—Crease at a distance equal to one height plus one length of the box from the larger left end;

7—Diagonal creases.

FIG. 3 illustrates one embodiment of the self-assembling box for obtaining a tray with compact bottom, where the reference numbers represent:

1—Crease at a distance of half width of the box from the lower smaller end;

2—Crease at a distance of one height plus half the width of the box from the lower smaller end;

3—Crease at a distance of one height plus one and a half width of the box from the lower smaller end;

4—Crease at a distance twice the height plus one and a half width of the box from the lower smaller end;

5—Crease at a distance equal the height of the box from the larger left end;

6—Crease at a distance equal to one height plus one length of the box from the larger left end;

7—Diagonal creases.

FIG. 4 illustrates one embodiment of the self-assembling box for obtaining an exhibitor with cover and compact bottom, where the reference numbers represent:

1—Crease at a distance of half width of the box from the lower smaller end;

2—Crease at a distance of one height plus half the width of the box from the lower smaller end;

3—Crease at a distance of one height plus one and a half width of the box from the lower smaller end;

4—Crease at a distance twice the height plus one and a half width of the box from the lower smaller end;

5—Crease at a distance equal the height of the box from the larger left end;

6—Crease at a distance equal to one height plus one length of the box from the larger left end;

7—Diagonal creases.

FIG. 5 illustrates a scheme of the sheet of material that will be used for obtaining the self-assembling box, where the reference numbers represent:

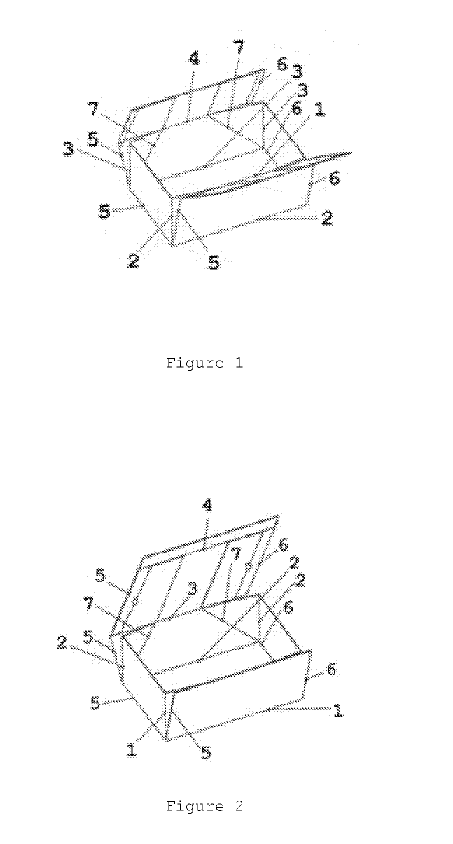

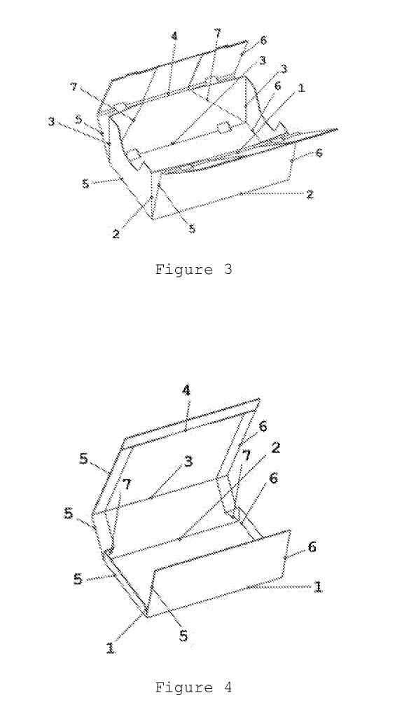

1—Crease at a distance of half width of the box from the lower smaller end;

2—Crease at a distance of one height plus half the width of the box from the lower smaller end;

3—Crease at a distance of one height plus one and a half width of the box from the lower smaller end;

4—Crease at a distance twice the height plus one and a half width of the box from the lower smaller end;

5—Crease at a distance equal the height of the box from the larger left end;

6—Crease at a distance equal to one height plus one length of the box from the larger left end;

7—Diagonal creases.

8—Gluing points.

### DESCRIPTION OF THE EMBODIMENTS

Next the self-assembling box will be described in greater detail with reference to some embodiments, which however are not intended to limit the scope of the present application.

In one embodiment of the self-assembling box, perpendicular and horizontal creases are made over the whole length and width of the faces of a sheet of the box material, such as corrugated cardboard, resulting in obtaining something that might resemble a mesh.

The position of the horizontal and vertical creases in the sheet of the box material is determined by the volume of the box to be executed, i.e. according to the length, height and width.

The process of obtaining the self-assembling box may be briefly described in three stages:
Elaboration of creases in the sheet of material;
Gluing;
Folding.

The elaboration of creases in the sheet of material, such as for example a corrugated cardboard sheet may be produced according to the following steps:
Placement of a sheet of material on a stable basis;
Elaboration of a crease at a distance of half width of the box from the lower smaller end (1) perpendicular to the length direction of the sheet of material;
Elaboration of a crease at a distance of one height plus half the width of the box from the lower smaller end (2) parallel to the crease made in the previous step;
Elaboration of a crease at a distance of one height plus one and a half width of the box from the lower smaller end (3) parallel to the crease made in the previous step;
Elaboration of a crease at a distance of one and a half width plus twice the height of the box from the lower smaller end (4) parallel to the crease made in the previous step;
Elaboration of a crease at a distance equal to one height of the box from the larger left end (5), perpendicular to the width direction of the sheet of material;
Elaboration of a crease at a distance equal to one height plus the length of the box from the larger left end (6), parallel to the crease made in the previous step;
Elaboration of four diagonal creases (7).

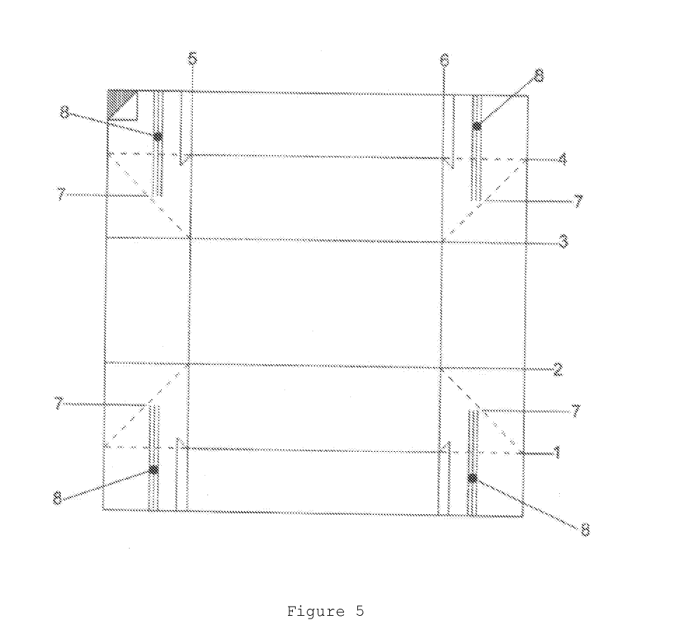

In a specific embodiment, the diagonal creases (7) may be at 45° and can be applied according to the points illustrated in FIG. 5.

The gluing step of the self-assembling box can be prepared in accordance with the following steps:
Introduction of some glue lines in four specific points of the sheet of material.

In a specific embodiment, the glue lines (8) may be applied at the points illustrated in FIG. 5.

The folding step of the self-assembling box can be prepared in accordance with the following steps:
The crease is folded at a distance equal to one height from the larger left end (5);
The crease is folded at a distance equal to one height plus one length from the larger left end (6);
The above folding glue the areas now in contact;
The creases are folded, laid horizontally to the sheet of material forming a box that opens in the middle of the sheet of material.

### APPLICATION EXAMPLES

During the development of the technical solution now presented, some tests with application examples were made that are now presented without this presenting a limitation to the scope of protection of the application.

For the elaboration of these application examples, it is considered an exemplary box volume of 200 mm in length, 150 mm in width and 100 mm in height. To obtain the self-assembling box it was found that the calculated area of the sheet of material directly corresponds to the box model to be held.

Thus, in one embodiment of the self-assembling box to obtain what is commonly termed as an American model box with compact bottom, the length of the sheet of material is equal to twice the height of the box to which one length of the box is added, with a total value of 400 mm. The width of the sheet is equal to twice the width of the box plus twice the height, with a total value of 500 mm.

In one embodiment of the self-assembling box to obtain what is commonly termed as box with cover and compact bottom, the length of the sheet of material is equal to twice the height of the box to which is added one length of the box, totalling a value of 400 mm. The width of the sheet is equal to twice the width plus twice the height of the box, with a total value of 500 mm.

In another embodiment of the self-assembling box to obtain what is commonly termed as tray with compact bottom, the length of the sheet of material will be equal to twice the height of the box to which one length of the box is added, totalling one value of 400 mm. The width of the sheet will be at least four times the height of the box plus the value of the width, totalling a value of 550 mm.

In another embodiment of the self-assembling box to obtain what is commonly termed as exhibitor with cover and compact bottom, the length of the sheet of material will be equal to half the height of the box to which one length of the box is added, totalling a value of 250 mm. The width of the sheet will be equal to twice the height of the box plus twice the width and of 30 mm, totalling a value of 530 mm.

This embodiment is of course not in any way restricted to the embodiments described herein and a person of ordinary skill in the area might provide many modification possibilities thereof without departing from the general idea, as defined in the claims.

The preferred embodiments described above are obviously combinable with each other. The following claims further define preferred embodiments.

1. Assembling process of a self-assembling box comprising the following steps:
placing a sheet of material on a stable basis;
elaborating a crease at a distance of half width of the box from a first lower smaller end perpendicular to the length direction of the sheet of material;
elaborating a crease at a distance of one height plus half the width of the box from a second lower smaller end parallel to the crease made in the previous step;
elaborating a crease at a distance of one height plus one and a half width of the box from a third lower smaller end parallel to the crease made in the previous step;
elaborating a crease at a distance of one and a half width plus twice the height of the box from a fourth lower smaller end parallel to the crease made in the previous step;
elaborating a crease at a distance equal to one height of the box from a first larger left end, perpendicular to the width direction of the sheet of material;
elaborating a crease at a distance equal to one height plus the length of the box from a second larger left end, parallel to the crease made in the previous step;
elaborating four diagonal creases;
introducing glue lines in four specific points of the sheet of material;
Folding the crease at a distance equal to the height of the box from the first larger left end;
Folding the crease at a distance equal to the height plus the length of the box from the second larger left end;
folding and contacting the glued areas;
folding the creases positioned horizontally to the sheet of material.

2. Assembling process of a self-assembling box according to claim 1, wherein the sheet of material is in corrugated paper, pasteboard or compact cardboard.

3. Self-assembling box obtained by the assembling method according to claim 1.

4. Use of self-assembling box described in claim 3 in the transport of objects and/or food products.
